(19) United States
(12) Patent Application Publication
(10) Pub. No.: US 2002/0166099 A1
(43) Pub. Date: Nov. 7, 2002

(54) Method of and system for making a semiconductor device

(76) Inventor: Arshad Madni, Swindon (GB)

Correspondence Address: THOMPSON HINE L.L.P., 2000 COURTHOUSE PLAZA , N.E., 10 WEST SECOND STREET, DAYTON, OH, 45402, US

(21) Appl. No.: 10/078,171

(22) Filed: Feb. 19, 2002

(30) Foreign Application Priority Data
Mar. 13, 2001 (GB) 0106090.4

(51) Int. Cl. G06F 17/50

(52) U.S. Cl. 716/1

(57) ABSTRACT

A technique is provided for making a semiconductor device having a first circuit block. This technique comprises analysing the first circuit block to determine its transfer function. The transfer function is then rearranged to resemble a known type of transfer function of a simpler circuit block whose performance is a known function of one of more parameters of the second transfer function. The value of the or each parameter which achieves a desired performance is derived from the known function and is used to calculate component values of the circuit block to be made so as to form a design. The design is then acted on so as to manufacture the device.

### BACKGROUND OF THE INVENTION

### Field of the Invention

The present invention relates to a method of and system for making a semiconductor device. For example, the semiconductor device may comprise part or all of an integrated circuit of analog type.

### SUMMARY OF THE INVENTION

According to a first aspect of the invention, there is provided a method of making a semiconductor device having a first circuit block, comprising analysing the first circuit block to determine a first characteristic function thereof, rearranging the first characteristic function to resemble a second corresponding characteristic function of a second circuit block having a performance which is a known function of at least one parameter of the second characteristic function, deriving from the known function a value of the at least one parameter which achieves a desired performance of the second circuit block, deriving from the value of the at least one parameter at least one value of at least one component of the first circuit block to form a design, and acting on the design to manufacture the semiconductor device.

The second circuit block may have fewer components than the first circuit block.

The second circuit block may have fewer active devices that the first circuit block.

The first circuit block may comprise a plurality of stages and the second circuit block may comprise a single stage.

The first and second characteristic functions may be transfer functions.

The first circuit block may have a differential topology and the second circuit block may comprise a long tail pair. The rearranged first transfer function may be of the form:

G=R1/(A+r)

where G is the gain, R1 is a load resistance, r is an internal electrode resistance 08 an active device, and A is an expression containing at least one parameter of the first circuit block.

The first circuit block may have a single ended topology and the second circuit block may have a single active device.

According to a second aspect of the invention, there is provided a computer programmed to perform a method according to the first aspect of the invention.

According to a third aspect of the invention, there is provided a computer program for programming a computer according to the second aspect of the invention.

According to a fourth aspect of the invention, there is provided a medium containing a program according to the third aspect of the invention.

According to a fifth aspect of the invention, there is provided a system for making a semiconductor device having a first circuit block, comprising an analyser for analysing the first circuit block to determine a first characteristic function thereof, means for rearranging the first characteristic function to resemble a second corresponding characteristic function of a second circuit block having a performance which is a known function of at least one parameter of the second characteristic function, means for deriving from the known function the value of at least one parameter which achieves a desired performance of the second circuit block, means for deriving from the value of the at least one parameter at least one value of at least one component of the first circuit block to form a design, and a manufacturing arrangement for manufacturing the semiconductor device from the design.

According to a sixth aspect of the invention, there is provided a method of designing a semiconductor device having a first circuit block, comprising analysing the first circuit block to determine a first characteristic function thereof, rearranging the first characteristic function to resemble a second corresponding characteristic function of a second circuit block having a performance which is a known function of at least one parameter of the second characteristic function, deriving from the known function a value of the at least one parameter which achieves a desired performance of the second circuit block, and deriving from the value of the at least one parameter at least one value of at least one component of the first circuit block to form a design.

It is thus possible to provide a technique which allows a circuit to be designed with a high probability that, when manufactured as a semiconductor device such as all or part of an integrated circuit, it will work correctly “first time” and will meet a desired performance specification. Some or all of the steps can be automated with relatively little user intervention in the design and manufacturing procedure. These techniques may be applied to any type of circuit, particularly analogue circuits, and a typical application is in the design and manufacture of mixer-oscillator circuits for radio frequency applications having low noise figures (NF) and high intermodulation distortion performance, such as IIP 3. These techniques allow the time-to-market of new devices to be reduced.

This technique may be thought of as transforming the first circuit block, which may comprise a complex amplifier circuit or the like, into a second circuit block which is simpler and/or already analysed, such as a long tail pair amplifier. Component values for the second circuit block can be calculated and then, by relatively simple mathematics, the component values for the first circuit block can be determined.

### BRIEF DESCRIPTION OF THE DRAWINGS

The invention will be further described, by way of example, with reference to the accompanying drawings, in which:

FIG. 1 is a circuit diagram of a first circuit block to be manufactured as part of an integrated circuit;

FIG. 2 is a block schematic diagram of a system constituting an embodiment of the invention;

FIG. 3 is a flow diagram illustrating a method of making a device constituting an embodiment of the invention; and

FIG. 4 is a circuit diagram of a second circuit block in the form of a long tail pair.

### DESCRIPTION OF THE EMBODIMENTS

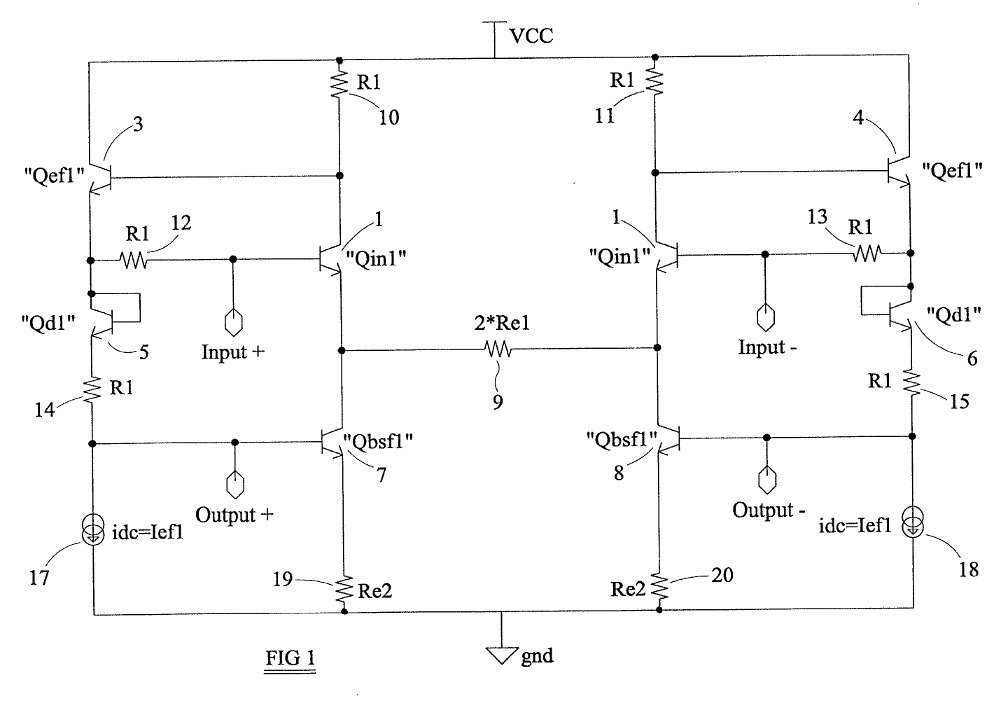

The first circuit block shown in FIG. 1 comprises a multi-stage differential amplifier for use in radio frequencies and for forming part or all of a new design of integrated circuit. The amplifier has differential inputs “Input+” and “Input−”, differential outputs “Output+” and “Output−”, a positive supply line Vcc and a ground connection gnd. The amplifier comprises npn bipolar transistors 1 to 8 with the transistors 1 and 2 comprising input transistors whose emitters are connected together by a resistor 9 of value 2 Re1. The collectors of the transistors 1 and 2 are connected to the supply line vcc by load resistors 10 and 11, respectively, each of value R1. The collectors of the transistors 3 and 4 are connected to the supply line vcc whereas the bases thereof are connected to the collectors of the transistors 1 and 2, respectively. The emitters of the transistors 3 and 4 are connected via resistors 12 and 13 to the bases of the transistors 1 and 2, respectively. The emitters of the transistors 3 and 4 are also connected via the transistors 5 & 6, which are connected as diodes, and resistors 14 and 15 to the bases of the transistors 7 and 8 and via constant current sources 17 and 18, respectively, to ground gnd. The collectors of the transistors 7 and 8 are connected to the emitters of the transistors 1 and 2 and the emitters of the transistors 7 and 8 are connected to ground gnd via resistors 19 and 20, respectively, each of which has a value Re2.

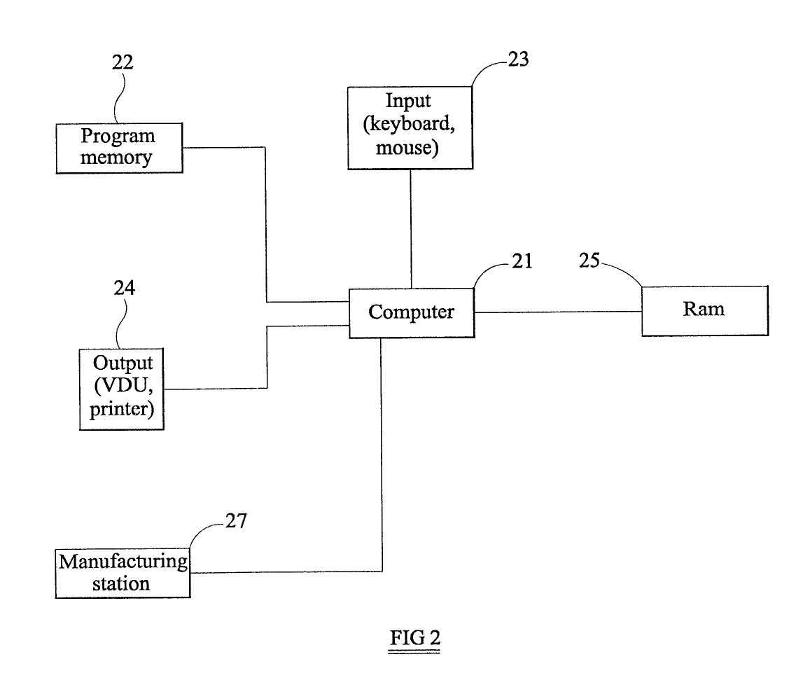

FIG. 2 illustrates a system for manufacturing a semiconductor device incorporating the amplifier illustrated in FIG. 1. The system comprises a computer 21 provided with a program memory 22 and a random access memory (RAM) 25. The computer has an input arrangement 23, for example comprising a keyboard and mouse, and an output arrangement 24, for example comprising a visual display unit (VDU) and a printer. The computer 21 also has an output connected to a manufacturing station 27 for converting a design into a manufactured semiconductor device such as an integrated circuit. Although the manufacturing station 27 is shown as a single block in FIG. 2, it may comprise various different parts which may be disposed at different locations. For example, the manufacturing station 27 may comprise means for turning the design into masks for the manufacture of integrated circuits, which masks are subsequently used elsewhere in an integrated circuit manufacturing plant.

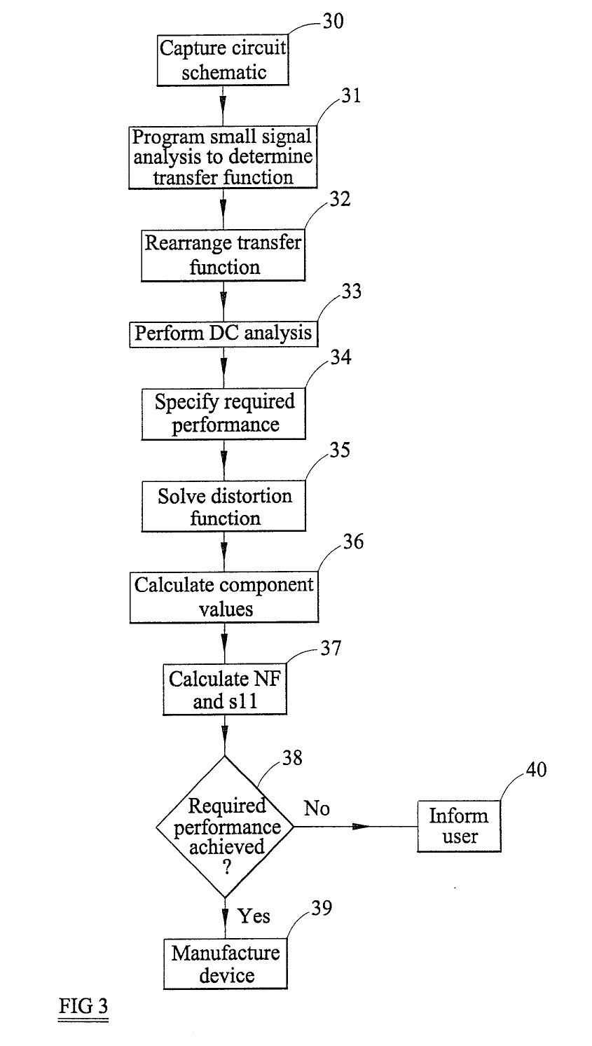

In order to design and manufacture the amplifier illustrated in FIG. 1 in an integrated circuit, the method illustrated in FIG. 3 is performed. In a first step 30, the circuit schematic is captured. This may, for example, be done within a computer aided design (CAD) program running on the computer 21 with the input devices 23 being used to capture the schematic. At 31, a small signal analysis of the circuit of FIG. 1 is performed so as to determine the transfer function of this circuit. This may be done automatically within the CAD environment or may be done manually. The result of the analysis gives the following transfer function:

$$G v = \frac{Rl}{Re 1 \cdot ( 1 + \frac{R1}{Re2 + re} ) + re} \qquad ( 1 )$$

Where Gv is the gain and re is the internal emitter impedance of each of the transistors 1,2,7 & 8.

By defining a parameter α as:

$$α = ( 1 + \frac{R1}{Re 2 + re} )$$

the transfer function may be rewritten as:

$$G v \frac{R1}{α \cdot Re 1 + re}$$

By rewriting α.Re1 as Re1′, this may in turn be rewritten as

$$G v = \frac{Rl}{{Re 1}^{′} + re} \qquad ( 2 )$$

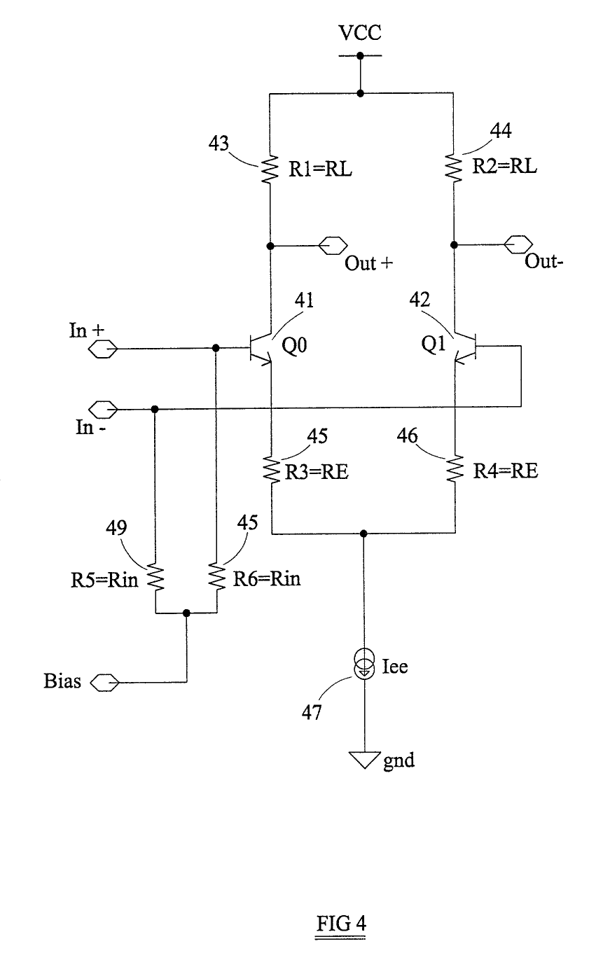

This expression for the transfer function of the first circuit block shown in FIG. 1 resembles the transfer function of a simple long tail pair of transistors constituting a second circuit block and shown in FIG. 4. The second circuit block thus comprises npn transistors 41 and 42 whose bases are connected to differential inputs “in+” and “in−” and whose collectors are connected to differential outputs “out+” and “out−”, respectively. The transistors 41 and 42 have collector load resistors 43 and 44, respectively, each of value R1, and emitter degeneration resistors 45 and 46, respectively, each of value Re. A constant current tail source 47 supplies a substantially constant current Ie and the bases of the transistors 41 and 42 are connected to a bias voltage source “bias” by resistors 48 and 49, respectively.

The transfer function of the second circuit block shown in FIG. 4 is given by:

$$G v = \frac{R1}{Re + re}$$

where re=2Vt/Iee, Vt=Kt/q, K is Boltzman's constant, T is temperature in degrees absolute and q is the charge in coulombs on an electron. The only signal-dependent term in the transfer function is re, which is the slope impedance of the transistors 41 and 42 for a given emitter current.

As is know, the emitter resistors 45 and 46 of value Re are resistive and form a negative feedback element of the long tail pair so that increasing the value Re reduces the gain of the amplifier and also reduces the distortion. However, increasing the value Re increases the noise figure (NF).

The performance of the second circuit block shown in FIG. 4 in terms of NF and third order distortion is a known function of Re and of re and is given by the following expression:

$$NF = 10 {log}_{10} \{ \frac{R s + \frac{{Rs}^{2}}{Rf} + {( \frac{Rs + Rf}{Rf} )}^{2} \cdot R amp}{R s} \}$$

where Rs is the source impedance of a signal source connected to the input, Rf is the effective resistance between each input and ground and Ramp is given by:

$$Ramp = 2 Re + 2 rbb + 2 \cdot \frac{{( Re + re + ( \frac{rbb + Rc}{β} ) )}^{2}}{R1} + re + \frac{1}{2 β \cdot r e} \cdot {( Re + R s + rbb )}^{2} + \frac{1}{2 β \cdot r e} \cdot {( Re + rbb )}^{2}$$

where rbb is the base spreading resistance of each of the transistors 41 and 42, β is the current gain of each of the transistors 41 and 42, and:

$$d3 = {( \frac{vin}{Vt} )}^{2} \cdot \frac{1}{48 \cdot {( 1 + \frac{Re}{r e} )}^{3}}$$

where d3 is the third harmonic distortion, vin is the peak amplitude of two sine waves applied to the inputs of the second circuit block and, in this case, re=50 mV/Iee.

Thus, for a given desired specification which the second circuit block 4 is required to achieve in terms of NF, Rin, d3 and vin, the values of the parameters R1, Re and re can be determined. Further, by rewriting the transfer function of the first circuit block shown in FIG. 1 so as to resemble the transfer function of the long tail pair shown in FIG. 4 as in equation (2), it is possible to use the above design equations for the second circuit block to determine the component values of components in the first circuit block which will allow the first circuit block to achieve the same performance specification.

The rearrangement for the transfer function of the first circuit block shown in FIG. 1 as performed in the step 32 includes a term Re1′ which differs from the transfer function of the long tail pair of the second circuit block in that it contains an “re” term. This implies the presence of an associated non-linearity which is attributable to the common emitter stages formed by the transistors 7 and 8. The bases of the transistors 7 and 8 are driven from the collectors of the transistors 1 and 2 via emitter followers formed by the transistors 3 and 4, respectively. Thus, the signals from the collectors of the transistors 1 and 2 are amplified and fed back in a negative sense to the bases of the transistors 7 and 8 via the emitter followers formed by the transistors 3 and 4, respectively. The distortion contribution of the transistors 7 and 8 is therefore higher than that of the transistors 1 and 2. Additionally, the distortion of these transistors is given by:

$$d3 = {( \frac{Gv \cdot vin}{Vt} )}^{2} \cdot \frac{1}{48 \cdot {( 1 + g m R )}^{3}} \qquad ( 3 )$$

where the term Gv is given by equation (2).

A step 33 performs a DC analysis of the first circuit block shown in FIG. 1 in order to determine operating points. From a simple analysis of the circuit path through the resistor 10, the base-emitter junctions of the transistors 3 and 5, the resistor 14, the base-emitter junction of the transistor 7 and the resistor 19, the following is obtained:

Vcc−3VBE−IxRx−I.(R1+Re2)=0

where Vcc is the supply voltage, VBE is the base-emitter voltage drop of a conductive silicon transistor, 1 is the current flowing through the transistors 1 and 7, Ix is the current flowing through the resistor 14 and Rx is the value of the resistor 14. If R1=m.Re2 and IxRx=0.2, then

I.(m+1).Re2=Vcc−3.VBE−02.

$$I Re 2 = \frac{Vcc - 3 \cdot VBe - 0.2}{m + 1}$$

If m=2, Vcc=4.75 and VBE=0.7, then

$$I R e 2 = \frac{V c c - 3 \cdot V B e - 0.2}{m + 1} = \frac{4.75 - 2.1 - 0.2}{3} = 0.82 or$$

or

$$\frac{I R e 2}{Vt} = \frac{0.82}{Vt} = 25 @ 130 deg C .$$

By substituting values into the transfer function (1) and multiplying the top and bottom of the right hand side expression by the current I,

$$\begin{matrix}Gv = \frac{I \cdot Rl}{I \cdot Re 1 \cdot ( 1 + \frac{R1}{R e 2 + re} ) + Vt} \\ = \frac{2 \cdot 0.82}{3 \cdot I \cdot Re 1 + 33 mV}\end{matrix}$$

At 34, the performance required of the first circuit block is specified and includes the requirement for IIP3 as 127 dBUV@94 dBuV Vin. The IM3 for whole circuit block is thus equal to (IIP 3−Vin)=66 dB. The first circuit block effectively comprises two stages so that the IM3 for each stage is equal to the IM3 for the whole block plus 6, that is 72 dB. The D3 value per stage is given the IM3 value per stage plus 10, that is 82 dB or (in scientific notation) 7.9e−5.

Substituting this into the equation (3) and rearranging gives:

$$\frac{Re 1 * ( m + 1 )}{re} = \sqrt[3]{{( \frac{71}{33} )}^{2} \cdot \frac{1}{48} \cdot \frac{1}{7.9 e - 5}} - 1 = 9.7$$

and substituting this value into the transfer function gives a gain of 4.6. The effective input voltage to each common emitter stage formed by the transistor 7 and 8 is therefore 163 mV and this gives a value of d3 for the common emitter stage of

$$d3 = {( \frac{163}{33} )}^{2} \cdot \frac{1}{12} \cdot \frac{1}{{( 1 + 25 )}^{3}} = 1.16 e - 4$$

This results in an overall value for IIP3 of 128 dBuV, which meets the distortion requirement specified in the step 34. The above-described solution of the distortion function is shown at 35 in FIG. 3.

In a step 36, the component values for the first circuit block are calculated on the basis of the parameter values established by the preceding distortion function solution. If the maximum allowed current through the transistors 1,2,7 and 8 is 12 mA, the value of re is 2.9 so that the value Re2 of each of the resistors 19 and 20 is 82 ohms. For m=2, the value R1 of each of the resistors 10 and 11 is 164 ohms and this gives a value of 9.3 ohms for Re1, which is the value of each of the emitter resistors 45 and 46 in FIG. 4. Rf has a value of 500 ohms and, with a source impedance of 152 ohms, this gives a value of s11 of 8.2 dB which, for example, meets a required performance specification for s11 of 7 dB as specified in the step 34.

The value of s11 and the noise figure NF are calculated in the step 37 and a step 38 determines whether the required performance specification has been achieved. If not, the user is informed at 40. Otherwise, the design comprising the schematic and all of the component values is used in a step 39 to manufacture the device as all or part of an integrated circuit. For example, an integrated circuit layout is generated from the schematic and the component values and is used to generate the appropriate masks which are then used in a subsequent integrated circuit manufacturing process.

What is claimed is:

1. A method of making a semiconductor device having a first circuit block, comprising the steps of:
analysing said first circuit block to determine a first characteristic function thereof;
rearranging said first characteristic function to resemble a second corresponding characteristic function of a second circuit block having a performance which is a known function of at least one parameter of said second characteristic function;
deriving from said known function a value of said at least one parameter which achieves a desired performance of said second circuit block;
deriving from said value of said at least one parameter at least one value of at least one component of said first circuit block to form a design; and
acting on said design to manufacture said semiconductor device.

2. A method as claimed in claim 1, in which said second circuit block has fewer components than said first circuit block.

3. A method as claimed in claim 1, in which said second circuit block has fewer active devices than said first circuit block.

4. A method as claimed in claim 1, in which said first circuit block comprises a plurality of stages and said second circuit block comprises a single stage.

5. A method as claimed in claim 1, in which said first and second characteristic functions are transfer functions.

6. A method as claimed in claim 1, in which said first circuit block has a differential topology and said second circuit block comprises a long tail pair.

7. A method as claimed in claim 6, in which said first and second characteristic functions are transfer functions and said rearranged first transfer function is of a form:
$$G = \frac{Rl}{A + r}$$
where G is a gain, R1 is a load resistance, r is an internal electrode resistance of an active device, and A is an expression containing at least one parameter of said first circuit block.

8. A method as claimed in claim 1, in which said first circuit block has a single ended topology and said second circuit block has a single active device.

9. A computer programmed to perform a method claimed in claim 1.

10. A computer program for programming a computer as claimed in claim 9.

11. A medium containing a program as claimed in claim 10.

12. A system for making a semiconductor device having a first circuit block, comprising an analyser for analysing said first circuit block to determine a first characteristic function thereof, means for rearranging said first characteristic function to resemble a second corresponding characteristic function of a second circuit block having a performance which is a known function of at least one parameter of said second characteristic function, means for deriving from said known function a value of said at least one parameter which achieves a desired performance of said second circuit block, means for deriving from said value of said at least one parameter at least one value of at least one component of said first circuit block to form a design, and a manufacturing arrangement for manufacturing said semiconductor device from said design.

13. A method of designing a semiconductor device having a first circuit block, comprising the steps of:
analysing said first circuit block to determine a first characteristic function thereof;
rearranging said first characteristic function to resemble a second corresponding characteristic function of a second circuit block having a performance which is a known function of at least one parameter of said second characteristic function;
deriving from said known function a value of said at least one parameter which achieves a desired performance of said second circuit block; and
deriving from said value of said at least one parameter at least one value of at least one component of said first circuit block to form a design.
